(19) United States
(12) Patent Application Publication
(10) Pub. No.: US 2013/0033057 A1
(43) Pub. Date: Feb. 7, 2013

(54) TRANSPORTABLE SELF CONTAINED RESTAURANT AND METHOD

(71) Applicant: James Markham, Carlsbad, CA (US)

(72) Inventor: James Markham, Carlsbad, CA (US)

(21) Appl. No.: 13/568,071

(22) Filed: Aug. 6, 2012

Related U.S. Application Data
(60) Provisional application No. 61/515,805, filed on Aug. 5, 2011.

(51) Int. Cl. B60P 3/025

(52) U.S. Cl. 296/22

(57) ABSTRACT

A transportable restaurant structure is provided employing a container structure such as a shipping container. An interior dining area is provided in-between sidewalls of the container as is a kitchen area. Sidewalls on the container are rotationally engaged to fold horizontal and provide adjoining areas to said dining area to increase its size. A door in an endwall is rotatable to provide an inclining ramp for walking or wheelchair access. The container is moveable by truck but once deployed takes on the appearance of a small restaurant with indoor and outdoor seating.

This application claims priority to U.S. Provisional Patent Application No. 61/515,805 filed Aug. 5, 2011, and which is included herein in its entirety by this reference.

### BACKGROUND OF THE INVENTION

1. Field of the Invention

The present invention relates generally to restaurant construction and operation of temporary restaurants which are transportable to seasonal venues such as the beach, county fairs, and for special occasions such as weddings. More particularly it relates to a fully operational restaurant structure with elevated patio which is customizable to an intended locale. Further, it is easily transported to the intended locale by a configuration allowing for deployment of the structure, elevated patio, and covering therefor from a stored form sized for transport protected within a shipping container.

2. Prior Art

Conventional restaurants and cafes in many areas of cities and towns are, by nature, permanent structures and are so intended. However, there are areas of town where restaurants are highly desirable, for certain long and very short periods of time. Such a transitory existence is required because the patronage for a full time restaurant in a building is insufficient to support the business year round, but restaurant services are highly desired for special events, or during periods of time where an area is highly occupied by people such as tourists.

Cities wishing to attract more tourists and their money are in a quandary in tourist-visited areas such as the beach. During summer or spring periods, the beach area of a city may be occupied by thousands of people for months at a time. However, in the off season, the same area may be so devoid of people that a permanent restaurant would suffer financial loss that would be intolerable.

Some cities and towns have tried to solve the problem of feeding visitors and locals who frequent areas like the beach or parks, waterfronts around lakes, and work sites, by allowing restaurants on wheels, or ‘food trucks’ to make stops. These vehicles are conventionally enclosed trucks outfitted with a compact kitchen. However, another method may include a trailer outfitted with a kitchen which is towed behind a towing vehicle.

In addition, there has been an increase in the number of gourmet style food trucks, which typically provide higher priced food for patrons at special events such as concerts, festivals, fairs, and the like. This method of food service is desirable for entrepreneurs due to low start up costs and maintenance costs, while allowing them to introduce their often unique cooking styles to the world. Further, patrons often enjoy this style of food service as they are able to try foods which may not be available otherwise.

However, such wheeled food service vehicles are often an eyesore and place patrons in lines in the street whereafter they have nowhere to sit and dine, often forcing patrons to sit on curbs or crowd public areas. The food from such transitory vehicles which do not carry the term ‘gourmet’, and even some that do, are generally less than adequate which is probably where the unseemly term “roach coach” for such vehicles originated. Further, gourmet style food trucks are typically expensive and therefore seem unfitting for this particular type of food service method, often deterring customers expecting cheap, fast food.

The employment of such restaurants on wheels for servicing patrons, where a permanent restaurant would not be financially viable, is therefore been a less than adequate experience for both patrons and the cities and towns allowing them. The patrons stand in long lines and have nowhere to sit and dine with their less-than-stellar food and the owner of the moving restaurant on wheels only stays in locales short periods of time till moving to the next whereafter visitors go hungry.

Consequently, there exists a need for a permanent-appearing restaurant, with tables and chairs for dining and an actual kitchen, which is not an eyesore when temporarily placed. Such a deployable restaurant should preferably be one that is a modular moveable structure.

Prefabricated and modular buildings have provided convenient and efficient ways to construct homes as well as other structures. These buildings are manufactured off-site in advance and with standardized sections that are easily shipped and assembled. Such buildings provide a relatively inexpensive solution to the housing needs of individuals and even whole communities.

In addition, prior art has shown prefabricated or modular buildings that are also self contained as a transportable container. Such are found in US Pub. No. 2010/0018131A1 to Green, and US Pub. No. 2011/0041415A1 to Esposito. These, as well as similar art, provide additional utility in that components of the building are no longer transported separately, but as a unit within a single self-contained structure decreasing shipping costs. Further, on-site construction assembly time is further reduced even further reducing costs and thus increasing desirability of such types of structures.

However, these and other prior art teachings of self contained dwellings do no teach or suggest the employment of a conventional container, easily transported with existing trucking and lifting equipment and sized modular construction in a manner adapted to transform ideal for restaurants. Neither do the teachings of the prior art keep in mind the structural and spacial needs related to restaurant construction.

As such there is a continuing and unmet need for a self contained transportable restaurant building and seating area. Such a device, for easy and standardized transport, employ a conventional shipping container using configurations which are easily stored therein, and deployable therefrom after transport is provided by conventional trucking. Such a device while taking advantage of a protected and container-like shipping appearance, when deployed, should provide viewers the appearance and allow for the ambiance of a permanent restaurant. To that end it should have deployable tables and chairs with both patio and indoor dining. Finally, as noted, the housing and transport component for the device should preferably be configurable from conventional existing materials such as shipping containers and be easily assembled and constructed.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals of a portable restaurant which has a stored mode sized for transport inside the protected confines of on or a plurality of cargo or shipping containers. The container providing protection during shipment, should provide structure for the restaurant deployed therefrom. In the deployed state, the transportable restaurant preferably has both indoor and outdoor seating, and indoor kitchen and ordering facilities.

A conventional freight shipping container, also known as a intermodal container or ISO container, is generally a box shaped housing which extends anywhere from 8 feet to 56 feet in length and is defined by a bottom surface, top surface (roof), sidewalls for supporting the top surface, and endwalls often employing cargo style doors. Such shipping containers already have a plurality of modes of allowing their mounting and dismounting from flatbed type trucks, thereby rendering transport of the container and its deployable contents easily accomplished.

The restaurant device herein depending on the intended size when deployed at a venue, is generally constructed from one or a plurality of conventional shipping containers. Besides containing and transporting indoor and outdoor restaurant seating, the container is adapted to provide an interior dining section covered from the elements, and a kitchen portion.

Great utility is provided by the sidewalls of the shipped container in that they are preferably rotatably engaged to the bottom surface to thereby provide an elevated surface for outdoor and/or indoor seating. The area of the roof where walls are rotated out of engagement for seating purposes is reinforced provide means for continued horizontal suspension without the walls in place.

Using this configuration, once the device reaches the intended venue, the sidewalls can be rotated downward to align in a flat horizontal plane, substantially parallel with the bottom surface of the container. The walls so deployed provide support surfaces for elevated seating and dining, above the soil or asphalt at the venue maintaining patrons in a spaced engagement from the perils of a parking lot or paved or unpaved roadway when dining.

Additionally, the remaining conventional bottom surface area of the container, communicating between the two deployable patio areas, remains unobstructed. This multiple floor area configuration, using the center floor area of the container and the two deployable walls, defines one large dining area, or a plurality of connected smaller dining areas where patrons may walk between either outdoor area through the interior indoor dining area.

Support for the roof or top surface of the indoor dining area is maintained by a plurality of vertically extending support structures such as beams or pillars.

The kitchen portion of the device preferably includes rigid portions of sidewall and may employ one or a plurality of windows and vents as needed to satisfy building codes and regulations. The kitchen portion is generally reserved to house and store various kitchen handwear such as sinks, refrigerators, grills, burners, cabinets, etc.

The device provides a convenient and cost effective permanent-appearing restaurant structure that is compact and transportable so as to be easily employable for a day, a week or a month, or permanently in some instances. This is especially important in venues where municipalities have outlawed “coach” type kitchens due to their unattractive nature and hard to inspect food preparation. It is especially important in municipalities where a season may exist where restaurants are needed, which may be months long, such as summer at the beach. Conversely, at such venues during the winter, crowds are small and restaurant services unneeded. However, when needing to feed hungry beach-goers, a permanent appearing venue such as the device herein, is especially preferred due to the elimination of blight of coach-style food dispensing, and the transitory nature of those vendors.

While deployed, the restaurant device provides patrons with both indoor and outdoor seating and the ambiance of a conventional structured restaurant. The provision of protected indoor seating in hot or humid or especially sunny areas is particularly preferred by users, customers, and the municipalities regulating such services. The same is true of venues which might be especially cold such as ski resorts. However, the ambiance of outdoor dining is also provided by the design herein for venues which will accommodate it, such as beach resorts.

Further, by employing old or refurbished freight containers, the device herein further incorporates a means for recycling such containers which may no longer be sea-worthy. This is especially important in many countries and individual municipalities to further the ideals of sustainability. Further, since a permanent structure is not needed and hence not constructed for venues with short tourist seasons, no conventional and typically valuable building material is wasted or under used by the replacement of such structures with the deployable device herein. For users who may gain stature with states and municipalities through the use of green technology, the device and method herein do help eliminate unnecessary structures which may be subject to erosion and/or damage or destruction in venues such as beaches.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the invention to provide a transportable restaurant structure, employing freight shipping containers for housing the structure which when deployed, appears to users at ground level, as a conventional eatery.

It is a further object of the invention to provide a such a transportable restaurant structure, protected by a storage container, but deploying to provide separate dining and protected kitchen facility areas.

It is still a further object of the invention to employ deployable sidewall portions to create additional outdoor dining spaces which are elevated above the ground and which are connected by an indoor dining area.

It is a further object of the invention herein, to provide a sturdy and permanent appearing structure for customers, in venues which may not support such more than a few months a year, or, in venues where a permanent structure would become damaged or destroyed by weather or tide during certain months.

These and additional objects, features and advantages of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a top view of the device with the roof omitted showing the available floor space with the dining portion sidewalls in the open mode rotated downward to create additional outdoor dining areas.

FIG. 2 is an end view of the kitchen portion employing conventional cargo style doors in the closed mode.

FIG. 3 is an end view of the dining portion employing vertically opposing doors in the closed mode.

FIG. 4 is again a top view of the device showing a preferred floor plan depicting kitchen and dining hardware within the respective spaces.

FIG. 5 is a side view of the device showing a first dining area sidewall in the closed mode, further shown is the dining area entrance with bottom door portion providing a ramp or similar entrance platform and upper door portion providing a shade.

FIG. 6 is a bottom view of the device of FIG. 5 with only one dining area sidewall in the open mode providing outdoor dining.

FIG. 7 is another particularly preferred mode of the device depicting an end view with a pitched roof.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

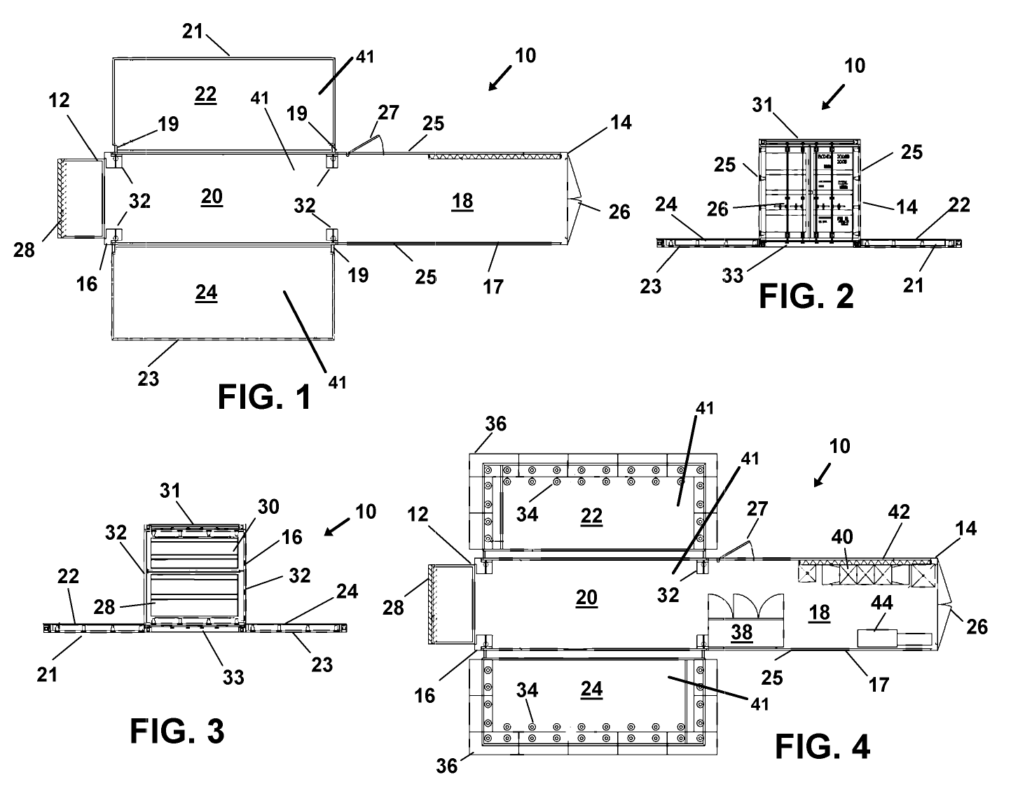

Now referring to drawings in FIGS. 1-7, wherein similar components of the transportable restaurant device 10 are identified by like reference numerals, there is seen in FIG. 1 a top plan view of a particularly preferred mode of the transportable restaurant device 10. The device 10 is formed by the adaptation of a conventional sized freight and storage container which is frequently used for ocean or rail transport of goods.

The device 10 is shown with a first end 12 and a second end 14 with respective first portion 16 and second portion 17. In a particularly preferred mode of the device 10 it is modular with the first portion 16 and second portion 17 may formed from two separate freight containers which are configured for being engaged on endwalls when deployed at a venue. The means for engagement is preferably a mechanical fastening of cooperating fasteners such as hooks and latches, but could be by fasteners or welding or simply by abutting two containers end to end.

However, in an alternative mode, serving a venue with a smaller customer population, the device 10 may be a single container merely separated into portions 16,17 as such. A major consideration being the employment of a freight container for the storage and transport of the appropriately sized and constructed contents, to allow for easy transport and subsequent deployment thereof, and especially to form an aesthetically pleasing permanent-appearing restaurant for customers at venues such as the beach or a street fair or civic event.

The device 10 as in the current figure has the roof 31 or top surface omitted from the view, in order to clearly see the elevated floor space below dining area 20 and kitchen area 18. However, in use the two portions 16,17, below dining area 20 and kitchen area 18 are covered by a roof 31 thereby providing an elevated support surface for diners and kitchen users, above the support surface on which the container sits.

Further, it is preferred that the first portion 16 comprises a first unobstructed indoor dining space or area 20. It is additionally particular preferred that the second portion 17 comprises the kitchen area 18, shown adjacent the dining area 20.

In a mode of the device 10 comprised of two containers which server as shipping housings for the contents, the dining area 20 and kitchen area 18 are provided in separate containers. This provides added utility in that if maintenance or cleaning is required in either area 18, 20, the servicing can be accomplished independently from one another.

It is further advantageous in the present invention to provide such an unobstructed dining area 20, providing elevated support for tables and chairs for patrons, above the ground or road surface, which is separate the kitchen facility 18. This unobstructed area provides a means for the device 10 to accommodate many more patrons than smaller individual separated areas. This is because tables and chairs may be arranged easier in a large area with no walls or obstructions, and passage to the tables and chairs my be afforded from one end to the other. This is unlike a dining area which has walls or obstructions between sections which require doors and pathways to the sections, and wall clearance issues, all of which diminish the amount of seating that can be provided.

Further, by employing a device 10 which has walls which fold down, to provide this unobstructed dining area which is elevated above the road, or dirt, or other surface, the ambiance of indoor dining at tables with chairs is provided which is unlike truck-style portable food preparation trucks which merely serves customers from open windows. As is often seen in prior art mobile or contained restaurant structures the kitchen area overlaps the dining area greatly effecting dining space and customer accommodation. The device herein, maximizes the area for patrons, provides an elevated support surface which may be cleaned and controlled which is much more sanitary than a parking lot, road surface, or bare ground which are subject to dirt, vermin, pathogens, and other problems. This is a major reason the device herein provides temporary restaurant services in municipalities which prohibit coach type food sales.

The first portion 16 further includes a first sidewall 21 and second sidewall 23. It is particularly preferred that the sidewalls 21,23 are rotatably engaged at or adjacent to the bottom surface 33 (FIG. 2) using means for rotational engagement such as by hinges 19 or the like. The sidewalls 21 and 23 engaged with the hinges 19 may preferably employ hydraulic powered rams, electric motors and worm style gears, or other means for applying a force for urging the sidewalls 21,23 from a vertical stored position, where they function as part of the container, to a substantially horizontal and open, as-used position, where the upper surface of both walls 21,23, is configured for use as an inline, evenly surfaced, elevated support area 41 for tables and chairs and patrons.

The hinged engagement of the sidewalls 21,23, is configured such that when folded to the horizontal position, the support area 41 extends substantially level or even, or at the same level above the underlying surface, to form an even surface for the entire dining area 20, to provide patrons and staff alike, the noted benefits of elevating the eating area. Further the formed substantially even surface of the support area 41 being substantially the same as the dining area 20, provides a means to prevent tripping of the patrons and gives the appearance of a restaurant.

As shown more clearly in the front and rear end views of FIG. 2 and FIG. 3, the sidewalls 21,23 are in the open mode rotated about the hinges 19 and aligned in a flat plane with the bottom surface 33. The sidewalls 21, 23 may employ operatively engaged winches, drive motor, or other suitable means for rotation of the walls into the horizontal position, and back to the vertical position. A winch, or hydraulic ram powered by an electric motor which may be engaged with grid-power or battery power operatively engaged is preferred, as the user will be able to achieve the horizontal as-used position, with the dining area 20 formed of the elevated support area 41, at the push a button.

It is an object of the present invention that the surfaces of the sidewalls 21,23 in the open or as-used mode, provide one or a plurality of additional outdoor dining areas shown as 22, 24 respectively, communicating with an indoor dining area 20. The provision of rotatable sidewalls 21, 23 allows the device 10 to triple the dining space while providing both indoor 20 and outdoor 22,24 dining spaces. Further, the entire dining space, while sectioned between the indoor 20 and outdoor 22,24 areas, is even as to elevation and is adjacent, thereby allowing patrons to walk right through the entire dining area. Having such an open area, which is level is advantageous as it allows for more tables and easier passage for patrons. As such it may be desirable to patrons who, in a conventional mobile restaurant setting, would be in a small segregated cramped area, or provided no dining area at all.

In a conventional freight container, the top surface or roof is structurally supported by the sidewalls, however to allow for the unique rotatable engagement of the dining area sidewalls 21, 23 of the present invention, to form a level patio or outdoor dinning surfaces 22, 24, the roof 31 support, when the sidewalls 21,23 are rotated horizontal, is maintained by a plurality of vertical support structures 32 such as beams, pillars, or the like located at corners within the dining area 20 communicating from the bottom surface 33 to the roof 31.

However, it is preferred that the remaining sidewalls 25 of the kitchen area 18 may remain as conventional rigid structural supports for shear support and to conform to building and kitchen codes and regulations if needed. Further shown in the rear end view of FIG. 2 are the conventional horizontally opposing freight doors 26 providing entrance into the kitchen area 18 away from the dining areas 20, 22, 24. This will allow workers to enter out of sight from the dining areas 20, 22, 24 and therefor patrons, and is therefor more akin to a conventional stationary restaurant.

To maintain aesthetics and to provide a more pleasing entrance, the first end 12 adjacent the dining area 20 preferably employs a first 28 portion and second 30 vertically opposing door portion that are rotatable in the vertical. Since conventional container doors are horizontally opposed as shown in the second end 14 of FIG. 2, this may be accomplished by retrofitting the endwall on the container end 12 which appropriate cuts and rotatable engagements, to form vertically opposed doors 28, 30.

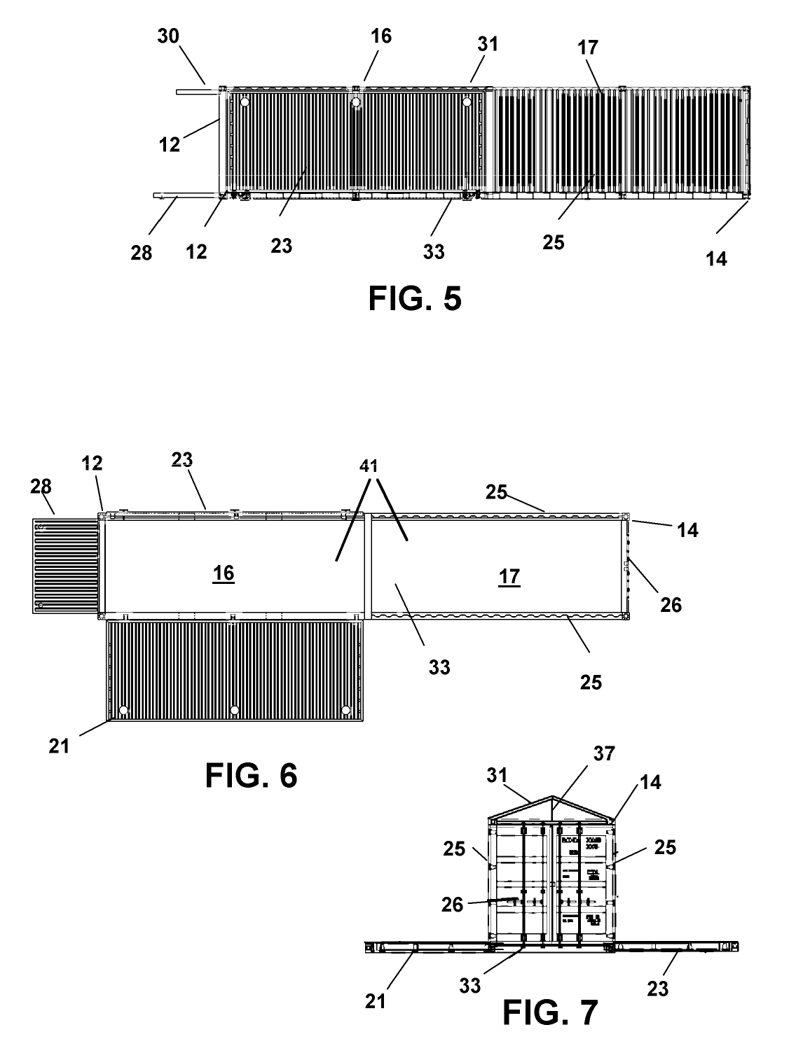

As will be shown more clearly in FIG. 5, the first, or lower door portion 28 formed of the endwall or end 12, is rotatably engaged to the dining area 20 and can be rotated downward to create a ramp or similar platform as an entrance to the dining area 20. Further, the second, or upper door portion 30 can be rotated upward, substantially horizontal, to provide shade for the dining entrance end 12, or it may be left downward to give the appearance of a door.

FIG. 4 shows again a top view of the device 10, with roof omitted, showing a particularly preferred example of a floor plan with kitchen hardware and other features depicted. The kitchen area 18 preferably employs conventional hardware such as refrigerator 38, sinks and burners 40, as well as storage containers 44. It is noted and anticipated other kitchen and restaurant related hardware known to those skilled in the art may also be employed, and are considered part of this disclosure.

Further the sidewall 25 of the kitchen area 18 may additionally include a side entrance 27 such as a door for food service to the outdoor areas 22, 24. The side door entrance 27 may be retrofitted into the conventional sidewall 25 of a container, or may be an OEM constructed door. It is additionally preferred that the kitchen area 18 include one or a plurality windows 42, vents, fire extinguishers, drains, and the like as needed for building codes or regulations.

Further shown employed on the outdoor dining areas 22, 24 are means to engage umbrellas or heaters provided by apertures 34, formed into the interior surfaces of sidewalls 21 and 23 as needed for shading or heating the outdoor dining areas 22, 24 as such. In this fashion, once the sidewalls 21,23 are folded to the as-used horizontal position, the apertures 34 will be positioned for engagement of poles for heaters umbrellas, or shade structure. In addition to apertures 34, such means for engaging umbrellas or heater can be any means known in the art. There is additionally provided tables 36, chairs, or other suitable seating means wherein patrons will be seated and served.

A first side view of the device 10 is shown in FIG. 5. Depicted in the current figure is a possible alternative preferred as used mode of the device 10 wherein the second dining area sidewall 23 is shown in the closed mode. This may be preferred if customer traffic is not expected to be relatively high and the additional outdoor dining area 24 provided by the sidewall 23 is not desired, or if wind prevails from that side so as to provide means to block wind to the dining area 24.

Further, as mentioned previously, the first end 12 employing a rotating lower 28 portion and upper 30 portion forming vertically opposing doors, are shown in the as used mode. The lower portion 28 is rotated downward to provide the ramp or similar platform as and entrance to the dining area 20 which may be used by walking patrons and wheel chair patrons alike which is a high priority to comply with various Federal codes for restaurants and serve all the public.

Additionally the upper portion 30 can be rotated and supported in a substantially horizontal orientation providing shade for the entrance at the first end 12. Rotation of the door portions 28, 30 may be accomplished by an operatively engaged wince, or other suitable means to allow the user to rotate the generally heavy doors. A bottom view of the mode of the device 10 of FIG. 5 is shown additionally in FIG. 6 with the first dining area sidewall 21 in the open as used position and the second dining area sidewall 23 in the closed position.

Still an additional particularly preferred mode of the device 10 is shown in an end view of FIG. 7. As depicted the roof 31 is preferably substantially pitched in a central portion as to create larger interior within the device 10 as well as provide improved drainage off of the roof in wet weather. It is further preferred that the roof 31, is rotationally engaged such that in a stored mode, it is substantially flat as is conventionally known in the art of freight containers. However in the as used mode the roof 31 is extended, constructed, assembled, or generally formed to include a pitch as shown. As such the roof 31 may be formed of multiple sections engaged on a track that allows the roof 31 to extend to such a pitch. There may be included a vertical support 37 for supporting the roof 31 in the pitched configuration. Again, an operatively engaged winch or other suitable means may be employed to achieve the pitched configuration.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A transportable restaurant structure comprising:
a container structure, said container structure having a top wall, a bottom wall, first sidewall, a second sidewall opposite said first sidewall, a first end wall, and a second end wall opposite said first end wall;
an interior defined by an area between said top wall, said bottom wall, said first and second sidewalls, and said first end wall and said second end wall;
said first end wall having a first door therein;
said second end wall having a second door thereon;
a first area of said bottom wall providing a support surface for a first dining area portion situated underneath said top wall, said support surface being elevated a distance above the ground or roadway supporting said container structure;
said first dining area portion providing a first means for supporting tables and chairs in an elevated position above said ground or roadway;
a second area of said bottom wall, providing a section for a kitchen portion, said kitchen portion configured for supporting kitchen hardware thereon, in an operable condition by kitchen personnel, whereby food for consumption upon said tables by patrons sitting in said chairs is preparable within said kitchen.

2. The transportable restaurant structure of claim 1 further comprising:
at least one sidewall of said first sidewall or said second sidewall being rotationally engaged to said restaurant structure at a lower end, said lower end being adjacent to said bottom wall and opposite an upper end adjacent to said top wall;
said at least one sidewall rotatable from a stored position substantially vertical and said upper end adjacent to said top wall, to an as-used position wherein it is substantially horizontal;
a supporting surface area of said at least one sidewall in said as-used position, defining a second dining area portion, said second dining area portion providing a second means for supporting said tables and said chairs in said elevated position, above said ground or roadway; and
said second dining area portion providing an outdoor dining area adjacent to said first dining area portion.

3. The transportable restaurant structure of claim 1 further comprising:
said first sidewall and said second sidewall being rotationally engaged to said restaurant structure at a respective lower end, said lower end being adjacent to said bottom wall and opposite a respective upper end, adjacent to said top wall thereof;
said first sidewall rotatable from a stored position substantially vertical and with said upper end thereof adjacent to said top wall, to an as-used position substantially horizontal;
a first supporting surface area of said first sidewall in said as-used position defining a second dining area portion, said second dining area portion providing a second means for supporting said tables and said chairs in said elevated position, above said ground or roadway;
said second sidewall rotatable from a stored position substantially vertical and with said upper end thereof adjacent to said top wall, to an as-used position substantially horizontal;
a second supporting surface area of said second sidewall in said as-used position defining a third dining area portion, said third dining area portion providing a third means for supporting said tables and said chairs in said elevated position, above said ground or roadway; and
said second dining area portion and said third dining area portion both providing respective areas for outdoor dining having an unobstructed overhead view.

4. The transportable restaurant structure of claim 3 further comprising:
said first dining area portion and said second dining area portion and said third dining area portion, each having substantially equal said elevated positions above said ground or roadway, and forming a single contiguous dining area having a substantially level surface throughout.

5. The transportable restaurant structure of claim 2 further comprising:
said first door rotatably engaged to said container structure at a first end adjacent to said first dining area portion;
said first door rotatable from a substantially vertical position, to an inclining position with a distal end of said first door opposite said first end, adjacent to said ground or said roadway; and
said first door in said inclining position providing a ramp, said ramp providing walking access to said first dining area portion for walking diners and rolling access to said first dining area portion for diners in wheel chairs.

6. The transportable restaurant structure of claim 3 further comprising:
said first door rotatably engaged to said container structure at a first end adjacent to said first dining area portion;
said first door rotatable from a substantially vertical position, to an inclining position with a distal end of said first door opposite said first end, adjacent to said ground or said roadway; and
said first door in said inclining position providing a ramp, said ramp providing walking access to said first dining area and said second dining area and said third dining area portions for walking diners and rolling access to said first dining area portion for diners in wheel chairs.

7. The transportable restaurant structure of claim 4 further comprising:
said first door rotatably engaged to said container structure at a first end adjacent to said first dining area portion;
said first door rotatable from a substantially vertical position, to an inclining position with a distal end of said first door opposite said first end, adjacent to said ground or said roadway; and
said first door in said inclining position providing a ramp, said ramp providing walking access to said contiguous dining area for walking diners and a rolling access to said contiguous dining area for diners in wheel chairs.

8. The transportable restaurant structure of claim 4 further comprising:
said single contiguous dining area having no vertical obstructions thereon rising above said first dining area portion and said second dining area portion, and between said first dining area portion and said third dining area portion, and
said single contiguous dining area providing unobstructed walking access for walking diners and unobstructed rolling access for diners in wheelchairs throughout said single contiguous dining area.

9. The transportable restaurant structure of claim 7 further comprising:
said single contiguous dining area having no vertical obstructions thereon rising above said first dining area portion and said second dining area portion, and between said first dining area portion and said third dining area portion, and
said single contiguous dining area providing unobstructed walking access for walking diners and unobstructed rolling access for diners in wheelchairs throughout said single contiguous dining area.

10. The transportable restaurant structure of claim 1 further comprising:
the number of said containers being two;
a first of said two containers configured for an engagement in an end to end fashion, with a second of said two containers;
a respective said a bottom wall of said first container comprising said first dining area portion; and,
a respective bottom wall of said second container comprising said kitchen area portion.

11. The transportable restaurant structure of claim 3 further comprising:
the number of said containers being two;
a first of said two containers configured for an engagement in an end to end fashion, with a second of said two containers;
a respective said a bottom wall of said first container comprising said first dining area portion; and,
a respective bottom wall of said second container comprising said kitchen area portion.

12. The transportable restaurant structure of claim 4 further comprising:
the number of said containers being two;
a first of said two containers configured for an engagement in an end to end fashion, with a second of said two containers;
a respective said a bottom wall of said first container comprising said first dining area portion; and,
a respective bottom wall of said second container comprising said kitchen area portion.

13. The transportable restaurant structure of claim 3 further comprising:
apertures positioned upon one or both of said first supporting surface area of said first sidewall and said second supporting surface area of said second sidewall; and
said apertures configured for engagement with an end of a pole to provide means for supporting said pole in a position perpendicular to said first supporting surface area or said second supporting surface area.

14. The transportable restaurant structure of claim 5 further comprising:
apertures positioned upon one or both of said first supporting surface area of said first sidewall and said second supporting surface area of said second sidewall; and
said apertures configured for engagement with an end of a pole to provide means for supporting said pole in a position perpendicular to said first supporting surface area or said second supporting surface area.

15. The transportable restaurant structure of claim 6 further comprising:
apertures positioned upon one or both of said first supporting surface area of said first sidewall and said second supporting surface area of said second sidewall; and
said apertures configured for engagement with an end of a pole to provide means for supporting said pole in a position perpendicular to said first supporting surface area or said second supporting surface area.
